(19) United States
(12) Patent Application Publication
(10) Pub. No.: US 2008/0313081 A1
(43) Pub. Date: Dec. 18, 2008

(54) Method and Apparatus for Payment Service Using Bar Code

(76) Inventor: Joon-Sang Wee, Kyungki-do (KR)

Correspondence Address: MCDERMOTT WILL & EMERY LLP, 18191 VON KARMAN AVE., SUITE 500, IRVINE, CA, 92612-7108, US

(21) Appl. No.: 12/159,614

(22) PCT Filed: Dec. 27, 2006
(86) PCT No.: PCT/KR2006/005727

§ 371 Date: Jun. 27, 2008

(30) Foreign Application Priority Data
Dec. 27, 2005 (KR) 10-2005-0130502
Oct. 26, 2006 (KR) 10-2006-0104346

(51) Int. Cl. G06Q 30/00; G06Q 20/00

(52) U.S. Cl. 705/44

(57) ABSTRACT

A method and apparatus for a payment served based on a card of a purchaser instead of a wire or wireless card inquiry apparatus or a payment gateway program owned and managed by a merchant. The method includes confirming merchandising member store information provided after a merchant registers on a finance company for a member store to generate and provide merchandising member store identification information. Upon receipt of a transaction request made by a purchaser receiving a transaction bar code generated to include the merchandising member store identification information and detailed transaction information using a financial transaction card of the purchaser and the transaction bar code, the transaction bar code is read out to collect the merchandising member store identification information and then verify member store information of the corresponding merchant. An approval of a transaction made by the purchaser for the merchant is requested to a finance company.

### TECHNICAL FIELD

The present invention relates to a method and apparatus for a payment service allowing a purchaser to make payment without using a wire or wireless credit card inquiry apparatus or payment gateway program managed by a merchant.

### BACKGROUND ART

When a commercial transaction of payment and receipt takes place, a flow of money is generally created. A purchaser needs to pay a certain amount of money for a purchased item or service to a merchant. That is, an issue of payment and account settlement occurs commonly between a purchaser and a merchant. In modern society, the payment is being settled through various methods. For instance, the payment can be made by cash via currently used money or by transfer of money between bank accounts. For companies, the payment can be made through bill settlement. As credit card businesses are thriving, particularly, in South Korea, credit card usage becomes frequent, and a range of the usage becomes wide. Thus, a credit card payment system is being well developed for various business transactions.

In general, two essential pieces of information need to be satisfied for a commercial transaction via a card; they are, card information (hereinafter referred to as “card customer information” encrypted on a payment card issued by a card company to a purchaser, and merchant identification information (hereinafter referred to as “merchandising member store information” issued from a card company based on a contract between the merchant and the card company. Also, such information about an amount of payment and an installment statement (hereinafter referred to as “detailed transaction information”) is necessary. However, since the detailed transaction information is a fixed condition basically set for each transaction, this information is considered as a fixed value without variation. Therefore, key information in a card based transaction is to find out who (purchaser) makes payment to whom (merchant).

In more detail, a merchant makes a contract with each card company for a member store to receive the sales payment made by a card, and individual member store authentication numbers are given to the merchant according to the rule set by each credit card company. The given member store authentication numbers and the credit card customer information allow the card based payment.

A conventional card based payment procedure will be described with reference to FIGS. 1a and 1b.

FIG. 1a illustrates a conventional card inquiry apparatus managed by a merchant registered on a credit card company as a member store. FIG. 1b illustrates a card based payment procedure using the conventional card inquiry apparatus.

When a card based transaction takes place, as illustrated in FIG. 1b, a guiding statement “Please read a card” is displayed on a liquid crystal display (LCD) screen of the card inquiry apparatus 100 illustrated in FIG. 1a. A merchant who receives a card 200 from a purchaser swipes the card 200 through a card reader 110. The card inquiry apparatus 100 reads card customer information containing encrypted information about a card number, expiration date and others from a track II of a magnetic stripe 210 at the back of the card 200. The track II represents a card information region. Numerous pieces of card customer information are generated differently from each other depending on card types. For instance, for an integrated circuit (IC) card, the card customer information is read through an IC chip, and for a debit card, the card customer information is read through a track III.

As illustrated in FIG. 1b, numerous pieces of detailed information about the card based transaction including an amount of purchase and a total number of installment months are input by pressing key pads on the card inquiry apparatus 100. The card inquiry apparatus 100 makes a card based transaction approval based on the read card customer information and the input purchase amount and the total number of the installment months, and transfers the card based transaction approval to a card company issued the card to the purchaser through an approval mediating company. From card inquiry apparatus information generated during the card based transaction (in general, card terminal identification (ID)), the approval mediating company (hereinafter referred to as “service company” receiving the card based transaction approval statement searches for information about a member store where the approval-requested card is used. Afterwards, the service company adds the member store information to a card based transaction approval request statement and acquires the transaction approval to the card company. The card company receiving the card based transaction approval request statement inspection whether to approve the request based on the card customer information and the merchandising member store information, and transfers the inspection result to the service company, which in turn transfers the approval result to the card inquiry apparatus 100. The card inquiry apparatus 100 outputs a given approval number transferred from the card company and an approval slip, thereby completing the transaction approval procedure.

As described above, when a purchaser make payment via an actual card, a card inquiry apparatus managed by a merchant is used as a device acknowledging a member store which is to receive the sales payment. That is, a merchant who is to be paid should have and manage a wire or wireless card inquiry apparatus. As similar to the above described transaction approval procedure, for Internet shopping malls, a transaction takes place through a member store authentication procedure or a member store agency service using a payment gateway, which is an Internet based payment program. This similarity is resulted since a merchant who is to be paid is acknowledged merely through the above described procedure.

Hence, in the case where the payment can be made only by the above described procedure, even if a cardholder who is a purchaser wants to make payment by an actual credit card and a merchant of a member store wants to receive the card based payment, the purchaser may not make payment directly to the merchant via an actual credit card based transaction, which is generally the most optimum and safe card based transaction unless the purchaser visits the member store, or the merchant of the member store visits the purchaser with a wireless terminal.

### DISCLOSURE OF INVENTION

### Technical Problem

The present invention has been made to solve the foregoing problems of the prior art and therefore an aspect of the present invention is to provide a method and apparatus for providing a purchaser with a payment service using a card for use in a financial transaction instead of a card inquiry apparatus owned and managed by a merchant.

Another aspect of the invention is to provide a method and apparatus for offering a payment service using a card for use in a financial transaction when payments for daily-life related transactions including educational fees, insurance bills, utility bills, and rental fees, and business to business (B2B) transactions are made with difficulty using an actual card.

### Technical Solution

According to an aspect of the invention, the invention provides a method for a payment service using a bar code, the method including confirming merchandising member store information provided after a merchant registers on a finance company for a member store to generate and provide merchandising member store identification information; upon request from the merchant, collecting the merchandising member store identification information and detailed transaction information indicating a transaction that a purchaser needs to make for the merchant, and generating a transaction bar code to be provided to the purchaser and including the merchandising member store identification information and the detailed transaction information; upon receipt of a transaction request made by the purchaser provided with the transaction bar code using a financial transaction card of the purchaser and the transaction bar code, reading out the transaction bar code to collect the merchandising member store identification information and then verify member store information of the corresponding merchant; and requesting an approval of a transaction made by the purchaser for the merchant to a finance company corresponding to the financial transaction card using the collected detailed transaction information of the purchaser and the verified member store information of the merchant.

According to another aspect of the invention, the invention provides a method for a payment service using a bar code, the method including confirming merchandising member store information provided after a merchant registers on a finance company for a member store to generate and provide merchandising member store identification information; generating a transaction bar code to include the merchandising member store identification information and detailed transaction information indicating a transaction that a purchaser needs to make for the merchant, and providing the transaction bar code to the purchaser, both performed by the merchant, and upon receipt of a transaction request made by the purchaser provided with the transaction bar code using a financial transaction card of the purchaser and the transaction bar code, reading out the transaction bar code to collect the merchandising member store identification information and then verify member store information of the corresponding merchant; and requesting an approval of a transaction made by the purchaser for the merchant to a finance company corresponding to the financial transaction card using the collected detailed transaction information of the purchaser and the verified member store information of the merchant.

According to another aspect of the invention, the invention provides a server of a service company for providing a payment service using a bar code, the server including a transmission unit transmitting data with external devices; a control unit controlling and managing relationships between internal elements of the server; a merchandising member store identification information conversion unit performing a reciprocal conversion between merchandising member store information provided through which a merchant registers on a finance company for a member store and merchandising member store identification information; a storage device storing various pieces of merchants, purchasers, or transactions related information transmitted through the transmission unit and used or generated at internal devices; and a transaction bar code read-out unit reading out a transaction bar code of a purchaser provided through the transmission unit to collect information encrypted on the transaction bar code.

According to another aspect of the invention, the invention provides a card inquiry apparatus for use in a bar code based transaction, the card inquiry apparatus including a bar code read-out unit capable of reading a transaction bar code provided from a merchant or a service company; and a financial transaction card read-out unit collecting card customer information from a financial transaction card of a purchaser, wherein an approval request is sent out to a finance company corresponding to the financial transaction card using the bar code information collected through the bar code read-out unit and the card customer information of the purchaser collected from the financial transaction card read-out unit, and a card based transaction is performed based on an approval response transferred from the finance company.

### ADVANTAGEOUS EFFECTS

As set forth above, a method and system for a payment transaction using a bar code according to certain embodiments of the invention can be applied to a wide range of business transactions without being spatially and temporally limited by implementing member store authentication based on a bar code instead of a card inquiry apparatus and a PG, which is an Internet based transaction program. As a result, it is possible to provide the convenience in employing a card based transaction and safety in transaction by allowing a cardholder to make a direct transaction using an actual card. These effects can satisfy various demands in card based transactions, and thus, contributing to enhancement in card businesses. Furthermore, the card based transaction is still allowed without using a card inquiry apparatus or PG owned and managed by a merchant of a member store. Thus, those transactions related to educational fees, various taxes including local taxes, utility bills, telecommunication bills, and B2B bills can be made using a card. The implementation of the card based transactions can also contribute to eradication of illegal transactions, which are usually hardly discovered by the conventionally employed transactions.

### BRIEF DESCRIPTION OF THE DRAWINGS

The above and other objects, features and other advantages of the present invention will be more clearly understood from the following detailed description taken in conjunction with the accompanying drawings, in which:

FIG. 1A illustrates a conventional card inquiry apparatus managed by a merchant of a registered member store;

FIG. 1B is a flowchart illustrating a conventional card based transaction procedure using the card inquiry apparatus illustrated in FIG. 1a;

FIG. 2 is a configuration diagram of a system to show relationships between devices coordinating together to provide a payment service using a bar code according to an embodiment of the present invention;

FIG. 3 is a flowchart illustrating an initial procedure of providing an actual payment service in an intended payment service using a bar code according to another embodiment of the present invention;

FIG. 4 is a simplified flowchart for describing a payment service procedure using a bar code according to another embodiment of the present invention;

FIG. 5 is a simplified flowchart for describing a payment service procedure using a bar code according to another embodiment of the present invention;

FIG. 6 is a simplified flowchart for describing a payment service procedure using a bar code according to another embodiment of the present invention; and

FIG. 7 is a configuration diagram of a server of a service company for providing a payment service using a bar code according to another embodiment of the present invention.

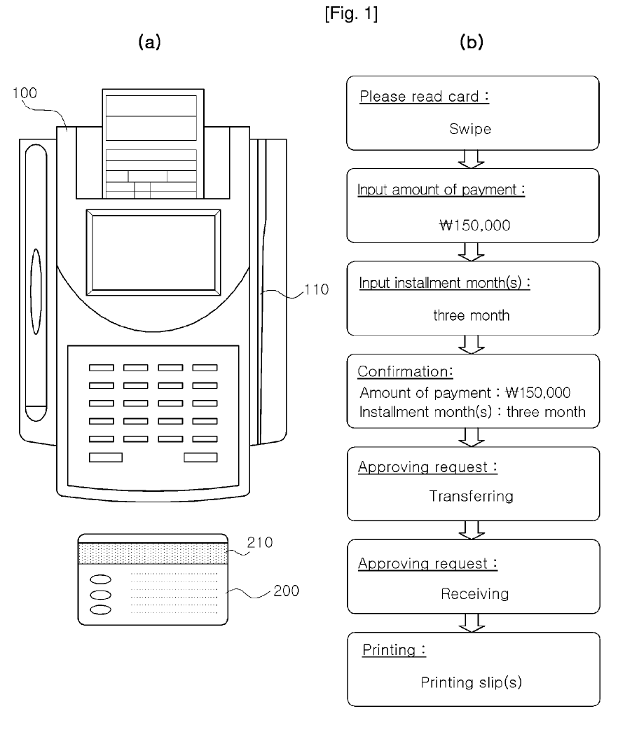

### BEST MODE FOR CARRYING OUT THE INVENTION

Preferred embodiments of the present invention will now be described in detail with reference to the accompanying drawings so as for those skilled in the art to easily implement the scope of the present invention. When the operational principles for various embodiments are described in detail, the related known functions or configuration will not be described fully if the detailed description thereof makes the scope and spirit of the present invention ambiguous.

Also, like reference numerals denote like elements providing like functions or actions in different drawings.

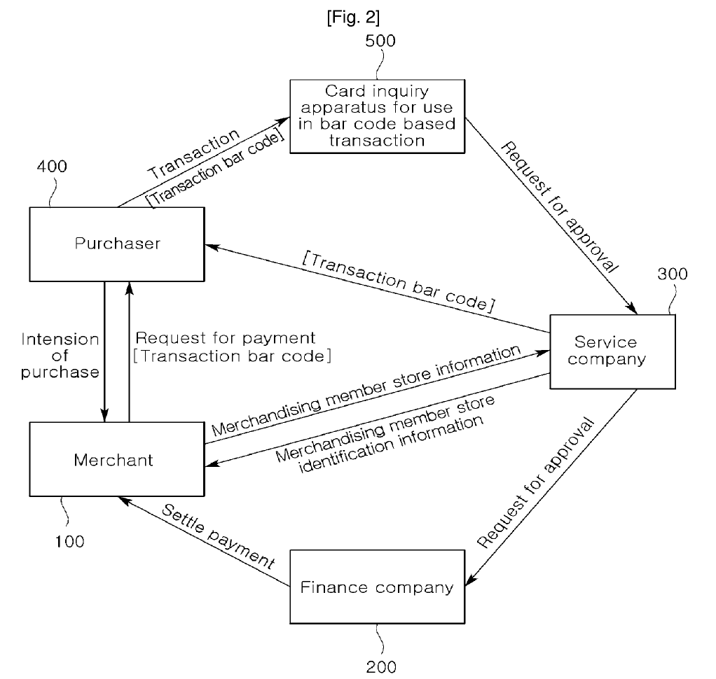

FIG. 2 is a configuration diagram of a system to show relationships between devices coordinating together to provide a payment service using a bar code according to an embodiment of the present invention.

For the payment service using a bar code, a merchant 100, a finance company 200, a service company 300, a purchaser 400, and a card inquiry apparatus 500 for use in a bar code based transaction need to coordinate together.

The finance company 200 provides the purchaser 400 with a portable card for use in a financial transaction (e.g., credit card, debit card, or cash card) in the form of a magnetic or IC card. When the purchaser 400 transacts a payment with the merchant 100 using the financial transaction card, the finance company 200 pays the charged amount to the merchant 100 instead of the purchaser 400. The finance company 200 to which the present embodiment can be applied may be a credit card company, a primary bank, or a secondary finance company.

The finance company 200 receives a member store request from the merchant 100, generates member store information for the merchant 100, and provides the generated member store information to the merchant 100 to pay the charged amount to the merchant 100 instead of the purchaser 400.

The merchant 100 requests a payment to the purchaser 400, and when the purchaser 400 transacts the payment using the financial transaction card, the merchant 100 receives the payment from the finance company 200. For this payment procedure, the merchant 100 provides directly the purchaser 400 with a transaction bar code generated to include merchandising member store identification information and a detailed transaction statement provided by the service company 300. Alternatively, the merchant 100 requests the service company 300 to provide the transaction bar code to the purchaser 400.

The merchant 100 to which the present embodiment can be applied includes any company manufacturing/selling a product or providing a certain service and requesting the compensational payment for this activity, or a public or government facility, a social voluntary association, or a religious association, which can request the non-compensational payment therefor.

The service company 300 receives the merchandising member store information given to the merchant 100 from the finance company 200, generates the merchandising member store identification information based on the received merchandising member store information, and provides the merchandising member store identification information to the merchant 100. The service company 300 also receives a request for an approval for which the purchaser 400 transacts the payment for the merchant 100 from the card inquiry apparatus 500, collects the merchandising member store identification information from the transaction bar code included in the request, converts the collected merchandising member store identification information into the corresponding merchandising member store information, and transfers the approval request to the finance company 200. Upon request from the merchant 100, the service company 300 generates a transaction bar code to include the merchandising member store identification information of the merchandising member store 400 and the detailed payment information, and provides the transaction bar code to the merchant 100 or the purchaser 400.

The purchaser 400 receives the transaction bar code along with a payment request from the merchant 100 or the service company 300, and then the purchaser 400 transacts the payment for the merchant 100 while inputting the financial transaction card and the transaction bar code to the card inquiry apparatus 500.

The card inquiry apparatus 500 collects the card customer information from the financial transaction card such as a credit card, a debit card, or a cash card and requests a transaction approval while providing the approval request for the transaction made by the purchaser 400 for the merchant 100 to the service company 300. At this time, the information collected from the transaction bar code provided to the purchaser 400 from the merchant 100 or the service company 300 is added to the transaction approval request. In the present embodiment, the card inquiry apparatus 500 can be obtained preferably by attaching a bar code reader that can recognize a bar code to the conventional card inquiry apparatus.

In the present embodiment, the card inquiry apparatus 500 displays the details of the transaction including the name of the merchant 100, items of the transaction, amounts of the payment, and the name of the purchaser 400, which are encoded in the transaction bar code read by the bar code reader from the purchaser 400, so that the purchaser 400 can verify the details of the transaction. After the verification, the purchaser 400 selects and inputs the number of an installment month. Then, the card inquiry apparatus 500 can make a request to the finance company 200 to allow the payment settlement between the merchant 100 and the purchaser 400.

The card inquiry apparatus 500 according to the embodiment of the present invention may be one form owned and managed by the merchant 100, or other forms of card inquiry apparatuses used in other member stores installed in banks, convenience stores, and public facilities.

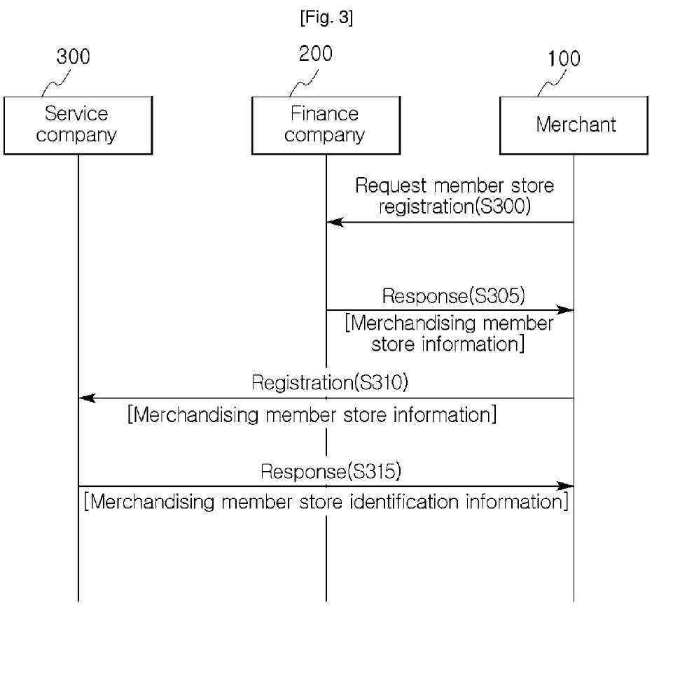

With reference to FIGS. 3 to 5, a method for a payment service using a bard code according to other various embodiments of the present invention will be described in detail.

FIG. 3 is a flowchart for describing an initial procedure of providing an actual payment service in an intended payment service using a bar code according to another embodiment of the present invention. For the initial procedure, a service company 300 generates merchandising member store identification information based on merchandising member store information provided from a finance company 200, and provides the merchandising member store identification information to a merchant 100.

In operation of S300, the merchant 100 requests member store registration to a plurality of the finance companies 200. For this request, the merchant 100 makes contracts with the multiple finance companies 200 for a member store and is registered as the member store. In operation of S305 each of the finance companies 200 provides the merchandising member store information in response to the request. Each of the finance companies 200 recognizes the merchant 100 based on the merchandising member store information when the card based transaction takes place.

In operation of S310, the merchant 100 receiving the merchandising member store information registers on the service company 300 for the bar code based payment service. The service company 300 needs information on the member store registration between the merchant 100 and the corresponding finance company 200 to provide the bar code based payment service. Thus, the service company 300 receives the merchandising member store information provided to the merchant 100 from the corresponding finance company 200, generates the merchandising member store identification information based on the merchandising member store information, and provides the generated merchandising member store identification information. In the present embodiment, the service company 300 can generate the merchandising member store identification information in one-dimensional or two-dimensional form and provide the merchandising member store identification information to the merchant 100.

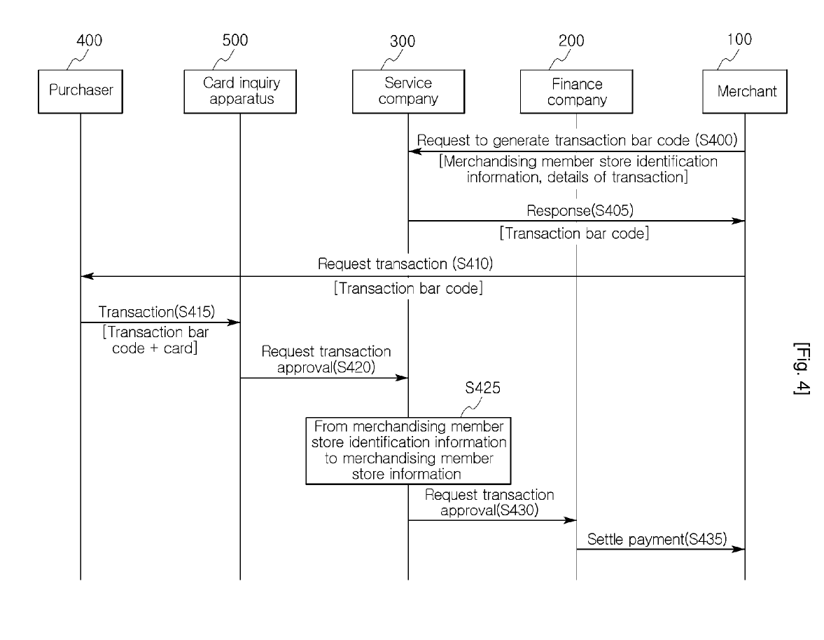

FIG. 4 is a simplified flowchart for describing a bar code based payment service procedure according to another embodiment of the present invention.

In operation of S400, a service company 300 receives a request to generate a transaction bar code from a merchant 100. For this request, the service company 300 receives merchandising member store identification information and detailed transaction information, which are usually necessary for generating the transaction bar code, from the merchant 100.

In operation of S405, upon the request, the service company 300 generates a transaction bar code and provides the transaction bar code to the merchant 100. The bar code generation can be done by the service company 300, or by other related bar code administration associations. In the present embodiment, the transaction bar code may be one selected from a group consisting of one-dimensional bar code represented in a two-bit basis with blocked and fine lines, two-dimensional bar code encoded in high density with two-dimensional symbols within a small square, and three-dimensional bar code.

In operation of S410, the merchant 100 requests a payment transaction to a purchaser 400. The payment transaction request is provided to the purchaser 400 along with the generated transaction bar code generated at the service company 300. Any method that can retain the information encoded in the transaction bar code without damage when read by another bar code reader can be used as a method that can be implemented to the present embodiment for providing the transaction bar code to the purchaser 400. For instance, a method of sending the transaction bar code printed on various billing statements or prints via a mailing service, a method of sending the transaction bar code through a short text message, or a method of inserting the transaction bar code into an e-mail on the Internet can be used.

When the merchant 100 makes the payment transaction request in the operation of S410, the merchant 100 may additionally provide information about details of the payment to the purchaser 400 for the convenience of the purchaser 400. For instance, in the case of sending the transaction bar code printed on the payment statement via a mailing service, in addition to the transaction bar code, items to be paid and amounts are additionally recorded on the payment statement in such a form that the purchaser 400 can directly acknowledge.

In operation of S415, the purchaser 400 receiving the payment transaction request transacts the payment using a card inquiry apparatus 500 for use in a bar code based transaction. That is, when the purchaser 400 receives the transaction bar code from the merchant 100 along with the payment transaction request, the purchaser 400 performs the transaction for the merchant 100 by inputting a financial transaction card of the purchaser 400 and the received bar code into the card inquiry apparatus 500. In addition to the card inquiry apparatus 500 owned and managed by the merchant 100, the purchaser 400 can perform the transaction described in the operation of S415 using another card inquiry apparatus for use in the bar code based transaction, which is not owned and managed by the merchant but installed in banks, convenience stores or public facilities.

In operation of S420, when the purchaser 400 performs the transaction as described in the operation of S415, the card inquiry apparatus 500 makes a transaction approval request to the service company 300 while providing the input transaction bar code information and the card customer information thereto.

In operation of S425, the service company 300 confirms the transaction bar code information provided from the card inquiry apparatus 500 and collects the merchandising member store information of the merchant 100 for which the purchaser 400 makes the payment transaction. Afterwards, based on the collected information, the service company 300 collects the merchandising member store information of the merchant 100.

At this time, the service company 300 collects the detailed transaction information, which indicates the transaction that the purchaser 400 needs to make for the merchant 100, from the transaction bar code information provided from the card inquiry apparatus 500.

In operation of S430, the service company 300 makes a transaction approval request to a finance company 200 using the card customer information provided from the card inquiry apparatus 500, the detailed transaction information verified by the transaction bar code, and the merchandising member store information.

In operation of S435, the finance company 200 inspects whether to approve the request based on the numerous pieces of the information provided from the service company 300 and completes the transaction for the merchant 100.

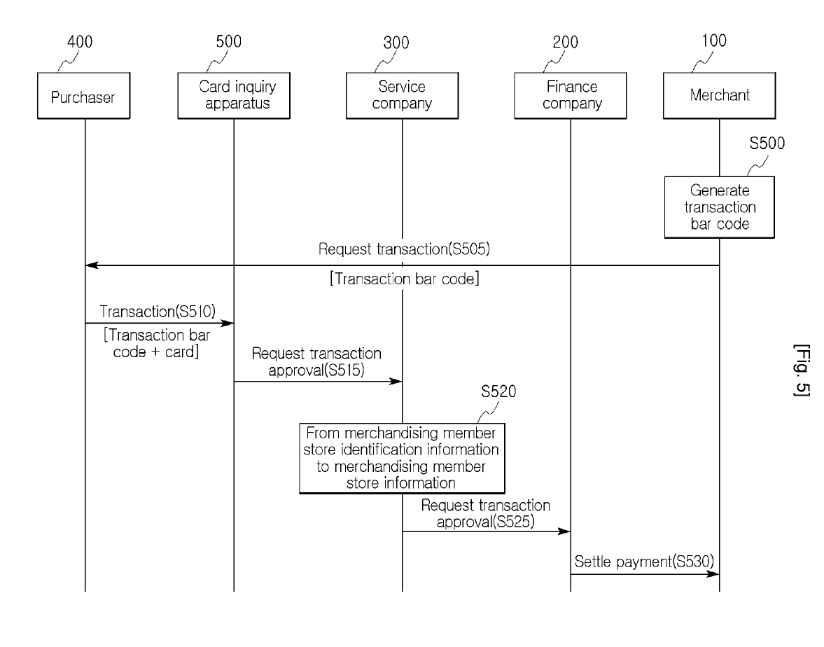

FIG. 5 is a simplified flowchart for describing a bar code based payment service according to another embodiment of the present invention.

In operation of S500, a merchant 100 generates a transaction bar code. For this transaction bar code generation, the merchant 100 generates the transaction bar code using merchandising member store identification information provided from a service company 300 and detailed transaction information billed to a purchaser 400 as similar to the illustration in FIG. 3. At this time, the bar code generation can be done by the service company 300 or other related bar code administration associations. In the present embodiment, the transaction bar code may be one selected from one-dimensional bar code represented in a two-bit basis with blocked and fine lines, two-dimensional bar code encoded in high density with two-dimensional symbols within a small square, and three-dimensional bar code.

In operation of S505, the merchant 100 makes a payment transaction request to the purchaser 400. The payment transaction request is provided to the purchaser 400 along with the transaction bar code generated by the merchant 100. Any method that can retain the information encoded in the transaction bar code without damage when read by another bar code reader can be used as a method that can be implemented to the present embodiment for providing the transaction bar code to the purchaser 400. For instance, a method of sending the transaction bar code printed on various billing statements or prints via a mailing service, a method of sending the transaction bar code through a short text message, or a method of inserting the transaction bar code into an e-mail on the Internet can be used.

When the merchant 100 makes the payment transaction request, the merchant 100 may additionally provide information about details of the payment to the purchaser 400 for the convenience of the purchaser 400. For instance, in the case of sending the transaction bar code printed on the payment statement via a mailing service, in addition to the transaction bar code, items to be paid and amounts are additionally recorded on the payment statement in such a form that the purchaser 400 can directly acknowledge.

In operation of S510, the purchaser 400 receiving the payment transaction request transacts the payment using a card inquiry apparatus 500 for use in a bar code based transaction. That is, when the purchaser 400 receives the transaction bar code from the merchant 100 along with the payment transaction request, the purchaser 400 performs the transaction for the merchant 100 by inputting a financial transaction card of the purchaser 400 and the received bar code into the card inquiry apparatus 500. In addition to the card inquiry apparatus 500 owned and managed by the merchant 100, the purchaser 400 can perform the transaction described in the operation of S510 using another card inquiry apparatus for use in the bar code based transaction, which is not owned and managed by the merchant but installed in banks, convenience stores or public facilities.

In operation of S515, when the purchaser 400 performs the transaction as described in the operation of S510, the card inquiry apparatus 500 makes a transaction approval request to the service company 300 while providing the input transaction bar code information and the card customer information thereto.

In operation of S520, the service company 300 confirms the transaction bar code information provided from the card inquiry apparatus 500 and collects the merchandising member store information of the merchant 100 for which the purchaser 400 makes the payment transaction. Afterwards, based on the collected information, the service company 300 collects the merchandising member store information of the merchant 100.

At this time, the service company 300 collects the detailed transaction information, which indicates the transaction that the purchaser 400 needs to make for the merchant 100, from the transaction bar code information provided from the card inquiry apparatus 500.

In operation of S525, the service company 300 makes a transaction approval request to a finance company 200 using the card customer information provided from the card inquiry apparatus 500, the detailed transaction information verified by the transaction bar code, and the merchandising member store information.

In operation of S530, the finance company 200 inspects whether to approve the request based on the numerous pieces of the information provided from the service company 300 and completes the transaction for the merchant 100.

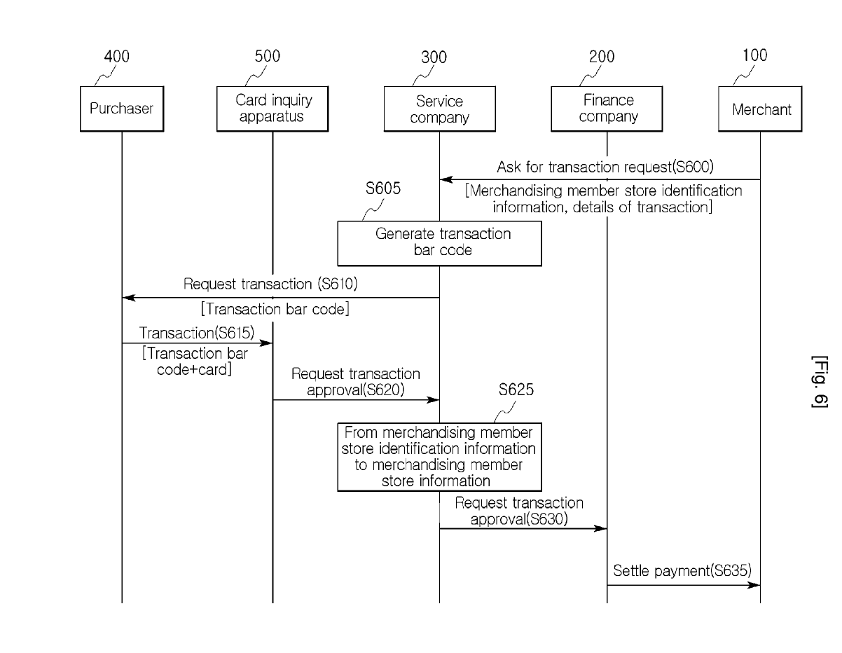

FIG. 6 is a simplified flowchart for describing a bar code based payment service according to another embodiment of the present invention.

In operation of S600, a merchant requests a service company 300 to ask for a payment transaction to a purchaser 400. For this request, the service company 300 receives merchandising member store identification information and detailed transaction information, which are usually necessary for generating a transaction bar code, from the merchant 100.

In operation of S605, upon the request, the service company 300 generates a transaction bar code. The bar code generation can be done by the service company 300, or other related bar code administration associations. In the present embodiment, the transaction bar code may be one selected from one-dimensional bar code represented in two-bit with blocked and fine lines, two-dimensional bar code encoded in high density with two-dimensional symbols within a small square, and three-dimensional bar code.

In operation of S610, the service company 300 requests the payment transaction to the purchaser 400. The payment transaction request is provided to the purchaser 400 along with the transaction bar code generated at the service company 300. Any method that can retain the information encoded in the transaction bar code without damage when read by another bar code reader can be used as a method that can be implemented to the present embodiment for providing the transaction bar code to the purchaser 400. For instance, a method of sending the transaction bar code printed on various billing statements or prints via a mailing service, a method of sending the transaction bar code through a short text message, or a method of inserting the transaction bar code into an e-mail on the Internet can be used.

When the merchant 100 makes the payment transaction request in the operation of S610, the merchant 100 may additionally provide information about details of the payment to the purchaser 400 for the convenience of the purchaser 400. For instance, in the case of sending the transaction bar code printed on the payment statement via a mailing service, in addition to the transaction bar code, items to be paid and amounts are additionally recorded on the payment statement in such a form that the purchaser 400 can directly acknowledge.

In operation of S615, the purchaser 400 receiving the payment transaction request transacts the payment using a card inquiry apparatus 500 for use in a bar code based transaction. That is, when the purchaser 400 receives the transaction bar code from the merchant 100 along with the payment transaction request, the purchaser 400 performs the transaction for the merchant 100 by inputting a financial transaction card of the purchaser 400 and the received bar code into the card inquiry apparatus 500. In addition to the card inquiry apparatus 500 owned and managed by the merchant 100, the purchaser 400 can perform the transaction described in the operation of S615 using another card inquiry apparatus for use in the bar code based transaction, which is not owned and managed by the merchant but installed in banks, convenience stores or public facilities.

In operation of S620, when the purchaser 400 performs the transaction as described in the operation of S615, the card inquiry apparatus 500 makes a transaction approval request to the service company 300 while providing the input transaction bar code information and the card customer information thereto.

In operation of S625, the service company 300 confirms the transaction bar code information provided from the card inquiry apparatus 500 and collects the merchandising member store information of the merchant 100 for which the purchaser 400 makes the payment transaction. Afterwards, based on the collected information, the service company 300 collects the merchandising member store information of the merchant 100.

At this time, the service company 300 collects the detailed transaction information, which indicates the transaction that the purchaser 400 needs to make for the merchant 100, from the transaction bar code information provided from the card inquiry apparatus 500.

In operation of S630, the service company 300 makes a transaction approval request to a finance company 200 using the card customer information provided from the card inquiry apparatus 500, the detailed transaction information verified by the transaction bar code, and the merchandising member store information.

In operation of S635, the finance company 200 inspects whether to approve the request based on the numerous pieces of the information provided from the service company 300 and completes the transaction for the merchant 100.

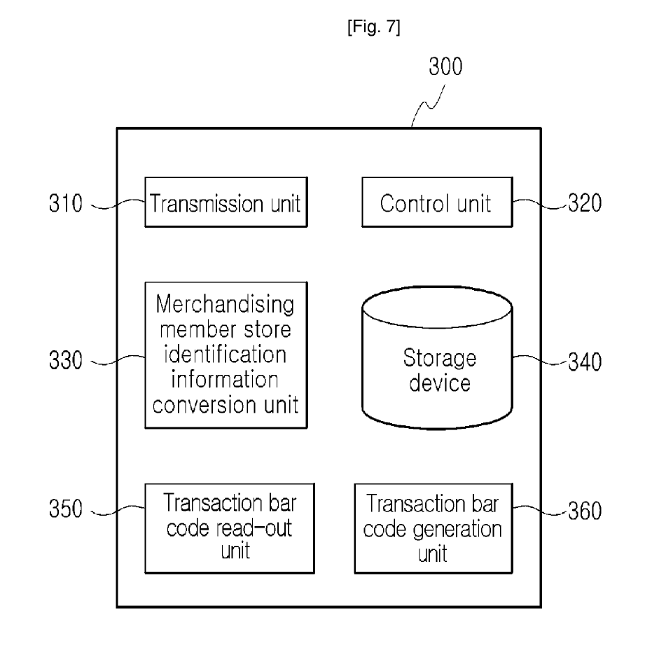

With reference to FIG. 7, a server of a service company for providing a payment service using a bar code according to another embodiment of the present invention will be described in detail hereinafter. FIG. 7 illustrates a configuration diagram of the server of the service company for providing the bar code based payment service in accordance with the other embodiment of the present invention.

The server 300 includes a transmission unit 310, a control unit 320, a merchandising member store identification information conversion unit 330, a storage device 340, a transaction bar code read-out unit 350, and a transaction bar code generation unit 360.

The transmission unit 310 is a wire or wireless communication device transmitting data with the devices coordinating together to provide the bar code based payment service as described in FIG. 2. Depending on need, the transmission unit 310 may include additional devices including modulation/demodulation modules and an amplifier.

The control unit 320 controls and manages relationships between internal elements of the server 300.

The merchandising member store identification information conversion unit 330 reciprocally converts merchandising member store information, provided by which a merchant makes a registration request for a member store to a finance company, and merchandising member store identification information.

The storage device 340 is a volatile or non-volatile memory device on which various pieces of merchants, purchasers, and transactions related information transmitted through the transmission unit 310 or used or generated at internal devices are stored. Types of the storage device 340, and kinds and amounts of the information stored on the storage device 340 can be determined by the selection of one skilled in the art depending on the confidentiality relationship accompanied for financial transactions.

The transaction bar code read-out unit 350 reads out a transaction bar code of a purchaser provided through the transmission unit 310 to collect information encrypted on the transaction bar code.

The transaction bar code generation unit 360 generates a bar code including the merchandising member store identification information generated at the merchandising member store identification information conversion unit 360 for the corresponding merchant and transaction information indicating the transaction performed by the purchaser for the merchant. In the present embodiment, the transaction bar code may be one selected from one-dimensional bar code represented in two-bit with blocked and fine lines, two-dimensional bar code encoded in high density with two-dimensional symbols within a small square, and three-dimensional bar code.

While the present invention has been shown and described in connection with the preferred embodiments, it will be apparent to those skilled in the art that modifications and variations can be made without departing from the spirit and scope of the invention as defined by the appended claims.

1. A method for a payment service using a bar code, the method comprising:
confirming merchandising member store information provided after a merchant registers on a finance company for a member store to generate and provide merchandising member store identification information;
upon request from the merchant, collecting the merchandising member store identification information and detailed transaction information indicating a transaction that a purchaser needs to make for the merchant, and generating a transaction bar code to be provided to the purchaser and including the merchandising member store identification information and the detailed transaction information;
upon receipt of a transaction request made by the purchaser provided with the transaction bar code using a financial transaction card of the purchaser and the transaction bar code, reading out the transaction bar code to collect the merchandising member store identification information and then verify member store information of the corresponding merchant; and
requesting an approval of a transaction made by the purchaser for the merchant to a finance company corresponding to the financial transaction card using the collected detailed transaction information of the purchaser and the verified member store information of the merchant.

2. The method according to claim 1, further comprising, between the step of collecting the merchandising member store identification information and the detailed transaction information and the step of reading out the transaction bar code, providing the transaction bar code to the purchaser and simultaneously making a transaction request, both performed by the merchant.

3. The method according to claim 1, further comprising, between the step of collecting the merchandising member store identification information and the detailed transaction information and the step of reading out the transaction bar code, providing the transaction bar code to the purchaser and simultaneously making a transaction request, both performed by a service company.

4. The method according to any one of claims 1 to 3, the merchandising member store identification information is generated in one form selected from a group consisting of one-dimensional, two-dimensional, and three-dimensional bar codes.

5. The method according to any one of claims 1 to 3, the transaction bar code is generated in one form selected from a group consisting of one-dimensional, two-dimensional, and three-dimensional bar codes.

6. The method according to any one of claims 1 to 3, wherein, in the step of reading out the transaction bar code, the purchaser is provided with the transaction bar code and detailed payment information.

7. The method according to any one of claims 1 to 3, wherein, in the step of reading out the transaction bar code, the transaction request made by the purchaser using the financial transaction card and the transaction bar code is performed employing a card inquiry apparatus for use in a bar code based transaction not owned and managed by the merchant.

8. The method according to any one of claims 1 to 3, wherein, in the step of requesting the approval of the transaction made by the purchaser, the transaction approval request is performed using the member store information of the merchant verified at the reading out of the transaction bar code, the detailed transaction information verified from the transaction bar code information, and card customer information.

9. The method according to any one of claims 1 to 3, further comprising, after the step of requesting the approval of the transaction made by the purchaser, inspecting whether to affirm the transaction approval request based on information provided from the service company and executing the transaction for the purchaser, both performed by the finance company.

10. The method according to any one of claims 1 to 3, wherein the financial transaction card includes one selected from a group consisting of a credit card, a debit card, and a cash card.

11. A method for a payment service using a bar code, the method comprising:
confirming merchandising member store information provided after a merchant registers on a finance company for a member store to generate and provide merchandising member store identification information;
generating a transaction bar code to include the merchandising member store identification information and detailed transaction information indicating a transaction that a purchaser needs to make for the merchant, and providing the transaction bar code to the purchaser, both performed by the merchant, and upon receipt of a transaction request made by the purchaser provided with the transaction bar code using a financial transaction card of the purchaser and the transaction bar code, reading out the transaction bar code to collect the merchandising member store identification information and then verify member store information of the corresponding merchant; and
requesting an approval of a transaction made by the purchaser for the merchant to a finance company corresponding to the financial transaction card using the collected detailed transaction information of the purchaser and the verified member store information of the merchant.

12. The method according to claim 11, wherein the merchandising member store identification information is generated in one form selected from a group consisting of one-dimensional, two-dimensional, and three-dimensional bar codes.

13. The method according to claim 11, wherein the transaction bar code is generated one form selected from a group consisting of one-dimensional, two-dimensional, and three-dimensional bar codes.

14. The method according to claim 11, wherein in the step of generating the transaction bar code, the purchaser is provided with information about details of the payment that the purchaser needs to make in addition to the transaction bar code.

15. The method according to claim 11, wherein, in the step of generating the transaction bar code, the transaction request made by the purchaser using the financial transaction card and the transaction bar code is performed employing a card inquiry apparatus for use in a bar code based transaction not owned and managed by the merchant.

16. The method according to claim 11, wherein, in the step of requesting the approval of the transaction made by the purchaser, the transaction approval request is performed using the member store information of the merchant verified in the step of requesting the approval, the detailed transaction information verified from the transaction bar code information, and card customer information.

17. The method according to claim 11, further comprising, after the step of requesting the approval of the transaction made by the purchaser, inspecting whether to affirm the transaction approval request based on information provided from a service company and performing the transaction for the purchaser, both performed by the finance company.

18. The method according to claim 11, wherein the financial transaction card includes one selected from a group consisting of a credit card, a debit card, and a cash card.

19. A server of a service company for providing a payment service using a bar code, the server comprising:
a transmission unit transmitting data with external devices;
a control unit controlling and managing relationships between internal elements of the server;
a merchandising member store identification information conversion unit performing a reciprocal conversion between merchandising member store information provided through which a merchant registers on a finance company for a member store and merchandising member store identification information;
a storage device storing various pieces of merchants, purchasers, or transactions related information transmitted through the transmission unit and used or generated at internal devices; and
a transaction bar code read-out unit reading out a transaction bar code of a purchaser provided through the transmission unit to collect information encrypted on the transaction bar code.

20. The server according to claim 19, further comprising a transaction bar code generation unit generating a transaction bar code including the merchandising member store identification information generated at the merchandising member store identification information conversion unit and transaction information about a transaction that the purchaser needs to make for the merchant.

21. The server according to any one of claims 19 and 20, wherein the member store identification information is in one form selected from a group consisting of one-dimensional, two-dimensional, and three-dimensional bar codes.

22. The server according to any one of claim 19 and 20, wherein the transaction bar code is in one form selected from a group consisting of one-dimensional, two-dimensional, and three-dimensional bar codes.

23. A card inquiry apparatus for use in a bar code based transaction, the card inquiry apparatus comprising:
a bar code read-out unit capable of reading a transaction bar code provided from a merchant or a service company; and
a financial transaction card read-out unit collecting card customer information from a financial transaction card of a purchaser,
wherein an approval request is sent out to a finance company corresponding to the financial transaction card using the bar code information collected through the bar code read-out unit and the card customer information of the purchaser collected from the financial transaction card read-out unit, and a card based transaction is performed based on an approval response transferred from the finance company.
